(19) United States
(12) Patent Application Publication
(10) Pub. No.: US 2026/0087305 A1
(43) Pub. Date: Mar. 26, 2026

(54) HOLOGRAPHIC GRAPH TRANSFORMER NETWORK (HGTN) SYSTEM AND METHOD

(71) Applicant: Leidos, Inc., Reston, VA (US)

(72) Inventors: Joshua P. Wilson, Reston, VA (US); Jackson D. Scott, Huntsville, AL (US); Christian A. Clark, Atlanta, GA (US); Bryce E. King, Arlington, VA (US); Olivia Galliker d’Aliberti, Hopewell, NJ (US)

(73) Assignee: Leidos, Inc., Reston, VA (US)

(21) Appl. No.: 19/338,057

(22) Filed: Sep. 24, 2025

Related U.S. Application Data
(60) Provisional application No. 63/698,539, filed on Sep. 24, 2024.

(51) Int. Cl. G06N 3/042; G06N 3/0455; G06N 3/092

(52) U.S. Cl. CPC G06N 3/042; G06N 3/0455; G06N 3/092

(57) ABSTRACT

A Holographic Transformer Network (HTN) system and method ingests and enriches semantic knowledge graph (KG) data using a holographic encoder and at least one non-GNN holographic transformer to produce graph node encodings in a node-count-mutable way. The produced node encodings can be used by a downstream network whose architecture is not tied to the static node defined by a particular vignette. The same network can be utilized for decision making even if the number of nodes in the graph (or entities in the simulation) increases.

### CROSS-REFERENCE TO RELATED APPLICATIONS

The present application claims the benefit of priority to U.S. Provisional Patent Application No. 63/698,539 entitled HOLOGRAPHIC GRAPH TRANSFORMER NETWORK (HGTN) SYSTEM AND METHOD filed Sep. 24, 2024, which is incorporated herein by reference in its entirety.

### COMPUTER PROGRAM LISTING

An Appendix hereto includes the following computer program listing which is incorporated herein by reference: “LEID0060_CodeAppendix.txt” created on Sep. 17, 2025, 84.7 KB.

### BACKGROUND

### Field of Embodiments

Generally, the field of the embodiments is expanding neural network architectures to create and enrich semantic vector representations for dynamic graph data.

### DESCRIPTION OF RELATED ART

Reinforcement learning (RL) is a pivotal area of study in the field of artificial intelligence that seeks to learn the optimal actions an agent should take in an environment to maximize the notion of cumulative reward. A crucial component of RL is constructing features that effectively represent the environment state to feed as input to the model. Often, this state is represented by a raster image or a simple vector of features, but these features could also be stored and organized in a knowledge graph, which is adept at handling the non-Euclidean data that is prevalent in complex decision-making scenarios.

However, to leverage these graphs for learning, they must be embedded into a vector space. The standard graph embedding methods often used in large language models (LLMs) are computationally expensive and typically assume the knowledge graph is static. Furthermore, these methods lack interpretability and are most beneficial when the graph size is considerably large, which does not always align with the dynamic and varying scales of RL environments.

Accordingly, there remains a need in the art for a method for creating holographic graph node encodings for instances where the knowledge graph is updated frequently.

### SUMMARY OF THE EMBODIMENTS

In a first non-limiting exemplary embodiment, a system for producing graph encodings of a representative environment for use in a reinforcement learning (RL) process includes: an ingestion component for ingesting knowledge graph (KG) data for the representative environment; a pre-processing component for producing a true adjacency data representation of the ingested KG data, wherein the true adjacency data representation includes node and edge attributes of the KG data; a holographic encoder for encoding the true adjacency data representation in accordance with selected encoding vectors; and at least one holographic transformer for enriching the encoded true adjacency data representation to produce at least one enriched adjacency data representation including increased adjacency hops, wherein the at least one enriched adjacency data representation is used to produce a fuzzy adjacency data matrix for use in an RL process related to the representative environment.

In a second non-limiting exemplary embodiment, a system for producing graph encodings of a representative environment for use in a reinforcement learning (RL) process includes: an ingestion component for ingesting knowledge graph (KG) data for the representative environment; a pre-processing component for producing a true adjacency data representation of the ingested KG data, wherein the true adjacency data representation includes node and edge attributes of the KG data; a holographic encoder for encoding the true adjacency data representation in accordance with selected encoding vectors; and multiple holographic transformers for successively enriching the encoded true adjacency data representation to produce multiple enriched adjacency data representations, wherein successive enriched adjacency data representations include increased adjacency orders, wherein the multiple enriched adjacency data representations are used to produce a fuzzy adjacency data matrix for use in an RL process related to the representative environment.

In a third non-limiting exemplary embodiment, process for producing graph encodings of a representative environment for use in a reinforcement learning (RL) process includes: ingesting, by an ingestion component, knowledge graph (KG) data for the representative environment; producing, by a pre-processing component, a true adjacency data representation of the ingested KG data, wherein the true adjacency data representation includes node and edge attributes of the KG data; selecting encoding vectors; encoding, by a holographic encoder, the true adjacency data representation in accordance with selected encoding vectors; enriching, by at least one holographic transformer, the encoded true adjacency data representation to produce at least one enriched adjacency data representation including increased adjacency hops; and producing a fuzzy adjacency data matrix from the at least one enriched adjacency data representation for use in an RL process related to the representative environment.

### BRIEF DESCRIPTION OF THE FIGURES

Example embodiments will become more fully understood from the detailed description given herein below and the accompanying drawings, wherein like elements are represented by like reference characters, which are given by way of illustration only and thus do not limit the exemplary embodiments herein.

FIG. 1 shows high-level schematic of an exemplary Holographic Transformer Network (HTN) system and process in accordance with embodiments herein.

FIGS. 2A and 2B are representative knowledge graph and corresponding true adjacency matrix in accordance with embodiments herein.

FIG. 3 is an exemplary actualized holographic encoder and transformer architecture in accordance with embodiments herein.

FIG. 4 is an exemplary architecture for the HTN network with downstream task in accordance with embodiments herein.

FIGS. 5A, 5B, 5C depict exemplary input matrix (FIG. 5A), decoded output (FIG. 5B), and resized output (FIG. 5C) for a trained model in accordance with embodiments herein.

FIG. 6 shows performance of HTN compared to a multi-layer perceptron (MLP) using holographic encodings in accordance with embodiments herein.

FIG. 7A shows a simplified grid layout clearly depicting movement restrictions, and FIG. 7B depicts the non-Euclidean, graph nature of the prior art Taxi environment.

FIG. 8 shows the comparison training curves for HTN, MLP and random actions in accordance with an exemplary Taxi environment embodiment described herein.

FIGS. 9A, 9B and 9C show HTN and MLP comparisons of mean success rate, average episode length and completion time for each policy type in accordance with embodiments herein.

FIGS. 10A and 10B show different random mazes generated by the prior art GymMaze environment, and FIG. 10C shows a graph representation of FIG. 10A.

FIGS. 11A, 11B, 11C graphs the results comparing HTN, MLP and random walk in accordance with an exemplary GymMaze environment embodiment described herein.

### DETAILED DESCRIPTION

In accordance with a preferred embodiment, a Holographic Transformer Network (HTN) is a system and method to ingest and enrich semantic knowledge graph (KG) data to produce graph node encodings in a node-count-mutable way. The produced node encodings can then be used by a downstream network whose architecture is not tied to the static node defined by a particular vignette. Thus, the same network can be utilized for decision making even if the number of nodes in the graph (or entities in the simulation) increases.

HTN is an efficient embedding technique for dynamic graphs to enhance decision-making in reinforcement learning of artificial intelligence agents. Graphs embedded using holographic embeddings compactly preserve relational information. By integrating graph-based representations, this capability aims to improve RL performance in complex environments. The HTN embeddings are injected into the RL state space-either as part of the agent's observation (e.g., the current node's embedding), as context (e.g., embeddings of goal entities or neighboring nodes), or as a structured input (e.g., concatenated paths or relation chains). This enables the agent to make decisions informed by the semantic structure of the knowledge graph while remaining compatible with standard neural network architectures (e.g., MLPs, RNNs, or GNNs) used in the policy and value networks.

With HTN, a learned encoding network converts a KG into a node encoding that captures states and observations about environmental data. The approach enhances decision-making of artificial intelligence (AI) agents by providing information from a scenario through non-graph neural network knowledge graphs, embeddings and transformers.

The architecture of this approach is designed to overcome the limitations of traditional graph learning approaches to RL. The HTN method, unlike traditional graph neural networks (GNNs), offers a flexible and scalable alternative when graph machine learning (ML) libraries are unavailable or undesired, and generalizes better than multi-layer perceptrons (MLPs) on unseen and larger graph data. It seamlessly integrates additional encodings, such as those from LLMs, into its process and is independent of the number of nodes or features, allowing for deployment in variable and expanding environments. Moreover, its design supports hierarchical stacking to capture subgraph ontologies and prioritize important edge types, enabling engineers to optimize model size and performance.

HTN's ability to learn to generalize to larger observations means it has broader and more general use applications compared to more traditional methods of employing reinforcement learning. It improves RL performance in complex environments like multi-agent systems or dynamic networks. Accordingly, in simulated environments, it can accomplish tasks as varied as training an unmanned surface vehicle, neutralizing adversaries attacking a protected asset, classifying molecules, navigating a maze, or taxiing a passenger to a destination.

HTN's ability to learn to generalize to larger observations means it has broader and more general use applications compared to more traditional methods of employing reinforcement learning. It improves RL performance in complex environments like multi-agent systems or dynamic networks. Accordingly, in simulated environments, it can accomplish tasks as varied as training an unmanned surface vehicle, neutralizing adversaries attacking a protected asset, classifying molecules, navigating a maze, or taxiing a passenger to a destination.

At its core, HTN creates holographic graph node encodings which use a basis set of functions and learned orthogonal transformations to encode graph data. A novel holographic transformer is used to utilize the holographic encodings in downstream ML tasks. A detailed description is provided below.

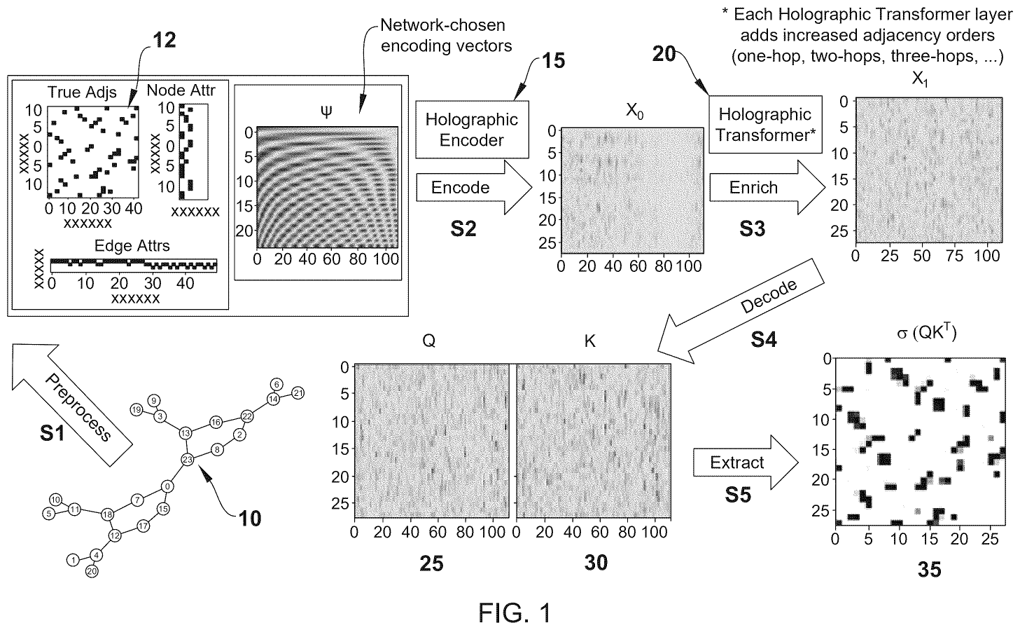

Referring to FIG. 1, the HTN workflow in accordance with the preferred embodiments entails taking arbitrary-size graph data with an arbitrary number of nodes or attributes and encoding it into a single, fixed-size, set of vectors that are independent of the number of nodes or attributes in the graph. The output is supplied to transformer architecture that refines those encodings. The enriched embeddings are then sent to a downstream process.

More particularly, in S1, the graph 10 is preprocessed to obtain the adjacency matrix 12 node/edge attributes and permutation of the nodes. In S2, the Holographic Encoder 15 uses chosen encoding vectors for each node size to create initial encodings X₀. Adjacency attributes are encoded into a single set of vectors that do not depend on the number of nodes in the graph. The output is sent to the holographic transformer 20. In S3, the holographic transformer 20 enriches the encodings X₁. As many holographic transformers can be added as needed, and this step can be iterated through different holographic transformers (20_{1-N}) repeatedly until the richness of the desired encoding is obtained. Each application of a holographic transformer adds increased adjacency orders. In S4, as part of a downstream task, decoding into a query (Q) 25 and key (K) vectors 30 occurs and a query and key vectors 30 produce a fuzzy representation (σ(QK^{T})) 35 of the adjacency matrix in S5. Steps S4 and S5 are happening inside the holographic transformer 20 with different heads. This allows the network to choose the important edges and features and amplify them in the representation.

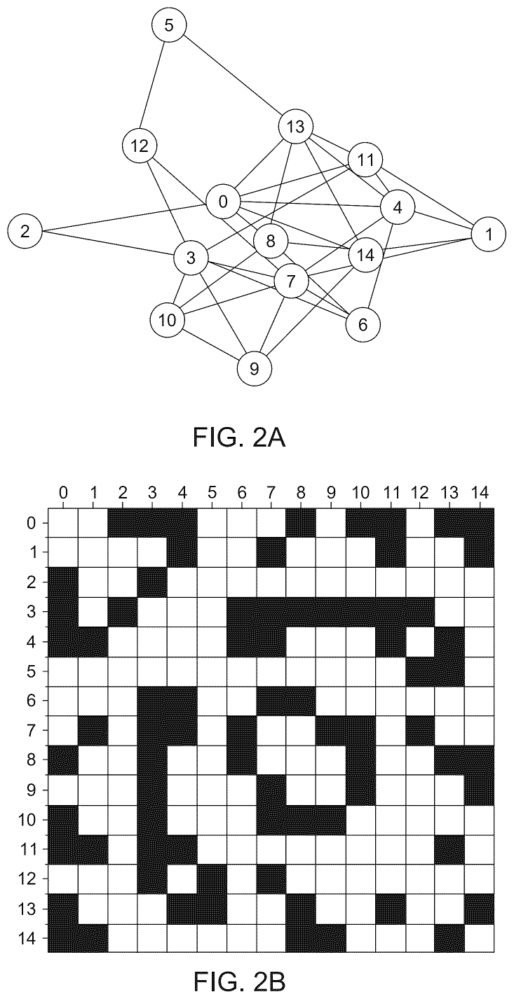

The preprocessing to obtain the adjacency matrix node/edge attributes and permutation of the nodes (S1 from FIG. 1) is described below. For machine learning tasks, one usually represents the graph 10 vertices and edges using an adjacency matrix 12. Referring to FIGS. 2A and 2B, elements of A, referred to as adjacencies, are defined as follows:

$${A}_{ij} = 1 if \{ {v}_{i} , {v}_{j} \} ∈ E and {A}_{ij} = 0 if \{ {v}_{i} , {v}_{j} \} ∉ E .$$

FIG. 2A visualizes the adjacency matrix for the graph represented in FIG. 2B. White pixels indicate a value of zero, and blue pixels indicate a value of 1. Note that for simple graphs, adjacency matrices are always symmetric, meaning A=A^{T}. Other commonly used graph matrices include the degree matrix D and the Laplacian matrix L. The elements of the degree matrix are given as

$${D}_{ij} = 0 if i \neq j and {D}_{ii} = \vert 𝒩 ( {v}_{i} , {v}_{j} ) \vert$$

where | [symbol] (vᵢ)| is the number of elements in the neighborhood of vᵢ, and the Laplacian matrix given as

$$L = D - A .$$

Additionally, there is a symmetrized version of the Laplacian matrix L_{sym} defined as

$${L}_{sym} = I - {D}^{- 1 / 2} {AD}^{- 1 / 2}$$

where I is the identity matrix and D^{-1/2} is the square root of the pseudoinverse of D.

Unfortunately, these graph matrices are not unique because they depend on the chosen ordering (or labeling) of the nodes. For instance, if the labels 0 and 1 in the graph depicted in FIG. 2A were swapped, it does not change the graph in a meaningful way, but it does change the adjacency matrix meaningfully. For a graph with n vertices, the number of individual adjacency matrices that will produce the same graph grows rapidly O(n!). This rapid growth means that distinguishing between two different graphs (even those with the same number of edges) solely based on their adjacency matrix is intractable. Therefore, if a neural network is to utilize an adjacency matrix for learning, then the adjacencies need to be built into the neural network architecture itself.

The adjacency matrix encoding and extraction (S2 from FIG. 1) are described below. Let G be a simple graph with Nₙ nodes and let f:V→{1, 2, . . . , N} be a labeling function, let A be the N×N adjacency matrix of G induced by f, and let Ψ be an N×T matrix whose columns are orthogonal vectors so that Ψ^{T}Ψ=I_{N} is the N×N identity matrix and, similarly, ΨΨ^{T}=I_{T}. Then, our node encodings consist of query matrices Q=AΨ^{T} and key matrices K=Ψ^{T}. Then, notice that Q and K are both N×T matrices, and the original matrix A is obtained with the matrix product QK^{T} as follows:

$${QK}^{T} = A {Ψ}^{T} Ψ = AI = A .$$

Now, we want to add these key and query matrices to get a single node encoding, doing so directly, as X=Q+K makes it difficult to extract the information easily because it becomes impossible to tell which contributions came from Q and which contributions came from K. Thus, taking the matrix product does not recover A, but instead results in a second order polynomial in A.

$${XX}^{T} = ( Q + K ) {( Q + K )}^{T} = {QQ}^{T} + {QK}^{T} + {KQ}^{T} + {KK}^{T} = {AA}^{T} + A + {A}^{T} + I = {A}^{2} + 2 A + I$$

Instead, define U_{Q} and U_{K} which are N×T orthogonal matrices, and instead define

$$X = {QU}_{Q} + {KU}_{K} .$$

Now, let M_{Q}, M_{K} be T×N matrices, let W be a bilinear operator, and construct the modified query and key matrices Q₁=XV_{Q} and K₁=XV_{K}, then, the product Q₁WK₁^{T} is given by

$$\begin{matrix}{Q}_{1} {WK}_{1}^{T} = ( {XV}_{Q} ) W ( {V}_{K}^{T} {X}^{T} ) = ( ( {QU}_{Q} + {KU}_{K} ) {V}_{Q} ) W ( {V}_{K}^{T} ( {U}_{Q}^{T} {Q}^{T} + {U}_{K}^{T} {K}^{T} ) ) \\ = {QU}_{Q} {V}_{Q} {WV}_{K}^{T} {U}_{Q}^{T} {Q}^{T} + {QU}_{Q} {V}_{Q} {WV}_{K}^{T} {U}_{K}^{T} {K}^{T} + {KU}_{K} {V}_{Q} {WV}_{K}^{T} {U}_{Q}^{T} {Q}^{T} + {KU}_{K} {V}_{Q} {WV}_{K}^{T} {U}_{K}^{T} {K}^{T} \\ = {QW}_{QQ} {Q}^{T} + {QW}_{QK} {K}^{T} + {KW}_{KQ} {Q}^{T} + {KW}_{KK} {K}^{T} \\ = {c}_{1} {AA}^{T} + {c}_{2} A + {c}_{3} {A}^{T} + {c}_{4} I \\ = {c}_{1} {A}^{2} + ( {c}_{2} + {c}_{3} ) A + {c}_{4} I ,\end{matrix}$$

where

$$W .. = U . {V}_{Q} W {V}_{K}^{T} U {.}^{T} ,$$

c₁, c₂, c₃, c₄ are real numbers, and the last line in the above equation requires A^{T}=A. The second to last step requires careful choices of U_{Q}, U_{K}, V_{Q}, V_{K}, and W. Notice that this the final expression for Q₁WK₁^{T} is similar to the final expression for XX^{T}, but allows for selection of coefficients in of the polynomial in A. More generally, if W, M_{Q}, M_{K}, U_{Q}, U_{K} are parametrized by θ, we have

$${Q}_{1} W {K}_{1}^{T} = {c}_{1} ( θ ) A {A}^{T} + {c}_{2} ( θ ) A + {c}_{3} ( θ ) {A}^{T} + {c}_{4} ( θ ) I$$

This resulting matrix is N×N and can serve as an operator for X.

The Holographic Encoder converts graph data into a vector of fixed size using the following method.

We first develop a method for encoding any N×N matrix (in particular, a graph adjacency matrix) into an N×T matrix where T is fixed. Let G be a graph with N nodes and let Λ_G={A,D,L} be the set containing the adjacency, degree, and Laplacian matrices for G. Let Λ_E be a collection of N×N edge properties and let D_N be set of N×1 node properties, and define the outer set of outer differences

$${Λ}_{N} = \{ {D}_{i}^{T} - {D}_{i} : {D}_{i} ∈ {D}_{N} \} .$$

Finally define Λ, the set of graph features to encode, as

$$Λ = \{ I \} ⋃ {Λ}_{G} ⋃ {Λ}_{E} ⋃ {Λ}_{N} ,$$

and notice that each matrix in Λ is an N×N. Define the initial holographic encoding as

$${X}^{( 0 )} = {\sum }_{B ∈ Λ} B Ψ {U}_{M} ,$$

where Ψ is a T×N matrix formed from a set of orthogonal vectors, and each U_{M} is a learned orthogonal matrix. The encoding X⁽⁰⁾ will serve as the initial input to the Holographic Transformer.

To obtain a fully arbitrary-sized encoding, independent of the number of nodes N, we perform an adaptive resampling along the node dimension to obtain a Ñ×T final encoding where Ñ is the number of “notional nodes.”

The holographic transformer is a graph neural network without the GNN. It is a regular transformer with extra layers to help with steering and filtering. Nonlocal message passing enriches encodings. The structure of the graph can be inferred rather than being provided directly. The holographic transformer method (S3 from FIG. 1) is detailed as follows. Let X be some N×T holographic encoding, and define Q, K, and V as follows:

$$Q = X {V}_{Q} , K = X {V}_{K} , and V = X {V}_{V} ,$$

where V_{Q}, V_{K}, and V_{V} are learnable T×T matrices. Then, QWK^{T} is a multinomial with variables M, M^{T} for each M ϵΛ. Now, define the updated encoding as

$${X}^{′} = X + σ ( Q W {K}^{T} + b ) V ,$$

where σ is the SoftMax function over the rows, and b is a learnable bias parameter. If W is factorable as

$$W = {W}_{Q} {W}_{K}^{T} ,$$

then the update step can be recast as

$${X}^{′} = X + σ ( Q {K}^{T} + b ) V ,$$

with Q=W_{Q}XV_{Q}, K=W_{K}XV_{K}.

This transformer-style architecture allows the aggregation function to be learnable, which makes the graph topology an inferred property. Applying this process repeatedly allows the network to enrich the encodings for a downstream process. Because this architecture is not dependent on the number of nodes or the length of the embedding, we can define a learnable node mixing and embedding mixing matrices, C_{N} and C_{T} respectively, so that the final encoding becomes

$${X}^{′} = {C}_{N} [ X + σ ( Q {K}^{T} + b ) V ] {C}_{T} ,$$

where X′ does not necessarily have the same number of notional nodes as X nor does it necessarily have the same embedding size. In practice, the full holographic transformer layer is defined as follows:

$${X}^{′} = Y + holoattn ( X ) ,$$

where X′ is the output encoding, X is the input encoding, holoattn(X) [symbol] σ(QK^{T})V, b is a learned bias, Q=Conv(Linear(X)) and similarly for K and V.

Compare this with prior art GNNs which build adjacencies into the neural network (NN) architecture directly. Each node vᵢ is given an initial encoding

$${\vec{x}}_{i}^{( 0 )} = encode ( {v}_{i} ) ,$$

a neural network layer NN₀ acts on the initial encoding to produce another encoding, and the encoding for adjacent nodes are aggregated. For example, with mean as the aggregation method, the next node

$${\vec{x}}_{i}^{( 1 )}$$

encoding is given as

$${\vec{x}}_{i}^{( 1 )} = N {N}_{0} ( {\vec{x}}_{i}^{( 0 )} ) + \frac{1}{\vert 𝒩 ( {v}_{i} ) \vert} {\sum }_{{v}_{j} ∈ N ( {v}_{i} )} N {N}_{0} ( {\vec{x}}_{j}^{( 0 )} ) .$$

Repeated iteratively with new layers NNₖ, it is possible to create higher-order encoding. For example, using a generic aggregation method agg, and collecting each of the encoding vectors into a single matrix X we obtain the follow recursion relation

$${X}^{( k + 1 )} = N {N}_{k} ( {X}^{( k )} ) + agg \{ N {N}_{k} ( {X}^{( k )} ) \} .$$

While a benefit of graph neural networks is that they can work with sparse matrices, which saves on computer memory and computation time, a major drawback is that each neural network is constrained to aggregate using user-provided discrete adjacencies. The embodiments described herein provide the network with an encoding of the adjacency matrix and allow the network to infer and alter the graph structure in a way that is optimal for a downstream task.

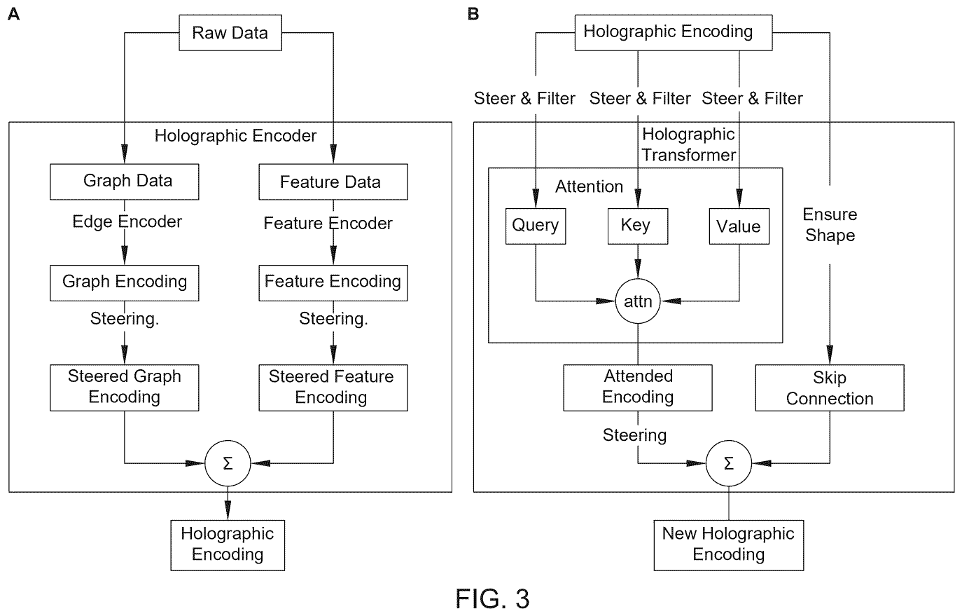

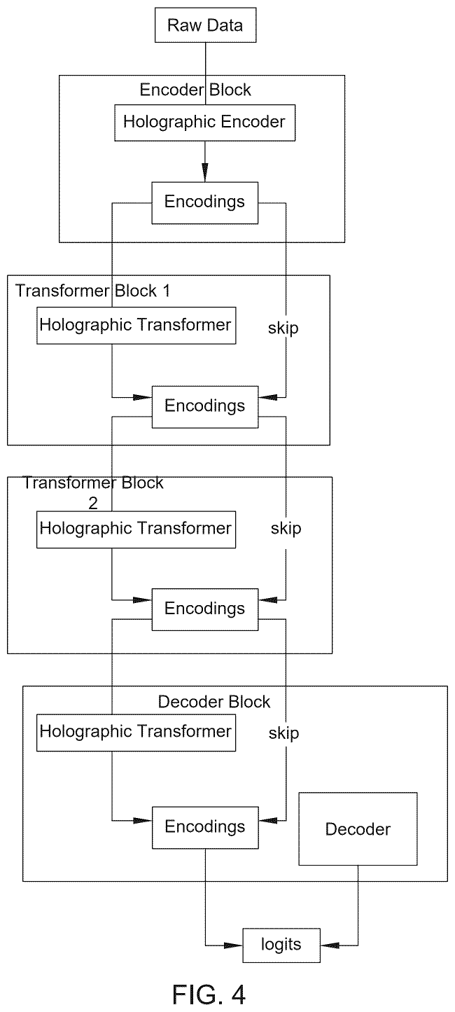

The convolution and linear layers are chosen so the shapes align. The convolutional operator Conv may be defined as a single 1D convolutional layer, a multilayer convolutional block, or have architecture like a UNet subcomponent. In this formulation, the linear layer performs the steering of the embedding while the convolutional layer performs a filtering of the encoding. FIG. 3 shows the actualized holographic encoder and transformer architectures. And FIG. 4 shows the architecture for the HTN network with downstream task.

The following descriptions of experiments and results thereof provide an assessment of the HTN's adjacency matrix autoencoder, graph classification, and reinforcement learning performance.

First, the holographic transformer method of the present embodiments was tested using the prior art MUTAG and ENZYMES datasets. We built HTN with encoding, holographic transformer, and decoding layers to encode and then reconstruct adjacency matrices. Its output was downsampled to the original size, and we computed the 2D binary cross entropy loss against the input adjacency. Effectively, this worked as an autoencoder for the graph matrices. Both node features and adjacencies from the MUTAG dataset were encoded.

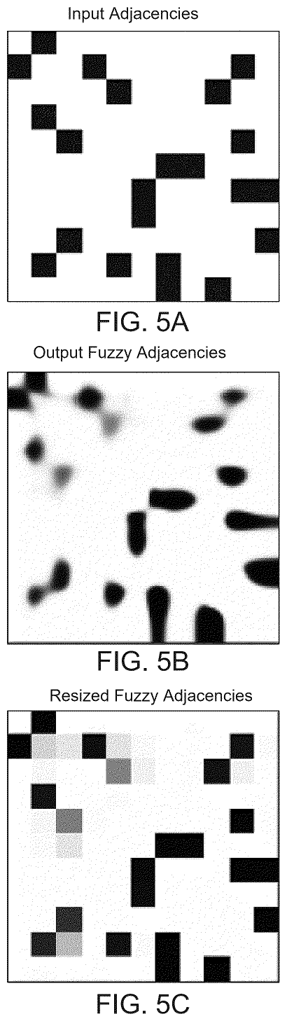

FIGS. 5A, 5B, 5C depict the input matrix (FIG. 5A), decoded output (FIG. 5B), and resized output (FIG. 5C) for a trained model. Importantly, with multiple decoder heads, the model can encode multiple different adjacency matrices in the same set of encoding vectors.

MUTAG is a classic benchmark dataset for graph classification tasks, primarily used in cheminformatics and molecular machine learning. It consists of 188 graphs, where each graph represents a nitroaromatic compound. Nodes correspond to atoms, labeled by their chemical types (such as carbon, oxygen, or nitrogen), and edges represent chemical bonds. The task is to predict whether a given compound is mutagenic, i.e., capable of causing genetic mutations, which makes this a binary classification problem. Due to its small size and relatively clean structure, MUTAG is widely adopted for evaluating the baseline performance of graph neural networks (GNNs) and graph kernels. Its simplicity allows for rapid experimentation while still capturing nontrivial molecular structure, making it a go-to dataset for initial validation of new graph-based models.

ENZYMES, on the other hand, presents a more complex challenge in the domain of bioinformatics. The dataset contains 600 protein graphs, each representing the tertiary structure of a protein molecule. Nodes correspond to secondary structure elements (such as α-helices and β-sheets), and node labels denote the specific type of structural component. Edges are defined based on spatial or biochemical proximity between these elements. The classification task involves predicting one of six enzyme commission (EC) classes, making this a multi-class graph classification problem. ENZYMES is particularly valuable as a benchmark because it introduces higher structural variability and semantic complexity compared to datasets like MUTAG. It is frequently used to assess the ability of graph models to capture biologically meaningful patterns in protein structures and to generalize across diverse molecular topologies.

The results are shown in TABLE 1.

TABLE 1

| Dataset | Method | Accuracy (%) |
|---|---|---|
| MUTAG | HTN | 86.26 |
| | DGK | 87.44 |
| | Evolution of Graph Classifiers | 100 |
| ENZYMES | HTN | 62.03 |
| | MLP + HE | 51.80 |
| | DGK | 53.43 |
| | ESA | 79.42 |

As the results demonstrate, for classifying the MUTAG dataset, HTN was slightly more accurate than the DGK method, but less accurate than the Evolution of Graph Classifiers method. For classifying the ENZYMES dataset, HTN outperformed ML+HE and DGK by <blank %> and <blank %>, respectively, but was less accurate than ESA.

Reinforcement Learning experiments with HTN include PyCOSMOS, Taxi and GymMaze. The PyCOSMOS experimentation introduced the foundations of a holographic embedding and holographic transformer to create interpretable node encodings for a knowledge graph when the knowledge graph is expected to change rapidly as in the case of reinforcement learning. The method for extracting encoded graph matrices was demonstrated to work in principle. Moreover, a network constructed from holographic principles had similar performance compared to a multilayer perceptron model, which is promising given the generalizable nature of the holographic network. The GymMaze and Taxi experiments also demonstrated that HTN quickly encodes and embeds graph data in a reinforcement learning context when the graph changes quickly. HTN, when paired with PPO, outperformed or maintained equivalent performance with all baselines tested. While slightly less performant than a similar MLP network, it takes fewer steps on average when it is successful.

The PyCOSMOS is a limited C4ISR simulator created by competitors during the Leidos 2023 AI Palooza competition. This competition served as the first testing environment for the HTN. Until the holographic encodings were created, no node encoding method we tested had been successful for this environment.

PyCOSMOS is a simplified version of COSMOS, a Command, Control, Communications, Computers, Intelligence, Surveillance and Reconnaissance (C4ISR) Space and Missile Operations Simulator. The scenario consists of four platforms: a VIP, two pirates (ATKs), and an Unmanned Surface Vehicle (USV). At the start of each scenario, each platform is positioned randomly, and the VIP has a goal location. The VIP travels at 20 knots, the pirates at 25 knots, and the USV at 30 knots. The pirates follow the VIP along pursuit curves, and the machine learning agent must control the USV to neutralize the pirates before either of the pirates boards the VIP. To neutralize a pirate, the USV only needs to get within a certain range of that platform.

For each experiment the following remain fixed: observation space, action space, reward function, policy training algorithm, normalization, and augmentation; however, the policy network is allowed to vary.

The observation consists of 4 vectors (one for each platform) with 5 components: the latitude and longitude of the platform as well as three discrete variables that reflect the platform type, which team the platform is on, and whether the platform is active.

The action space is the integers modulo 8, and each of the elements in the action space correspond to a steering direction for the USV. For instance, 0 corresponds to north, 1 corresponds to northeast, 2 corresponds to east and so on. During the simulation step, the bearing of the USV is set to the value corresponding to the action, and the USV moves in that direction for one time step.

The reward function is constructed to reward for good bearing each step while rewarding 100 for each instance a pirate is neutralized and 800 if all pirates are neutralized. The reward for good bearing depends on which pirate will board the VIP more quickly. Suppose that the first pirate will board the VIP in the shortest time. Notice that the 8 directions in the action space, which are distributed equally around the unit circle, can be well-ordered almost always where the order is given by the dot product of the USV bearing vector with the unit vector in the direction of the pirate. The ideal action is the action whose bearing would produce the largest dot product. The agent is then rewarded based on how close the action taken is to the ideal action.

The policy training algorithm is implementation of Proximal Policy Optimization (PPO) by the open source library for reinforcement learning (RLlib). The policy network varies with experiment, but RLlib provides a wrapper to any custom model using the PPO algorithm so that the output of the custom network should be the logits of the policy, not the probabilities.

To randomize latitudes and longitudes, at each step, a random rotation of the sphere is applied to the observation, and the inverse rotation is applied to the chosen action. Otherwise, due to the scenario choice, traveling northeast is a pretty good strategy that can be learned stochastically.

The latitudes and longitudes are randomized by the augmentation method; therefore, any sample could include latitude and longitude locations anywhere on the globe. This means that batch norm on its own is not useful since there is no meaning to “average value of latitude/longitude” since the average location of points on the surface of a sphere lies outside its surface. Instead, for each sample in the batch and for each attribute (latitude and longitude included) we perform a standard normalization over the platform dimension. In terms of a tensor of shape (N, C, L), where N is batch, C is nodes, and L is the features, the mean and standard deviation is taken over C. This localizes each observation to be centered at zero. Once the attributes are localized, a batch norm can be applied in a meaningful way. This means the set of all times when this does not occur has measure zero.

The control model always provides zeros for logits. This model is expected to perform poorly.

The Multilayer Perception (MLP) model flattens the 4 vectors in the observation into a single vector, which is then fed into a series of linear layers with ReLU (Rectified Linear Unit) activations and a hidden dimension of 100. The final output of the custom network is a vector of logits with length 8.

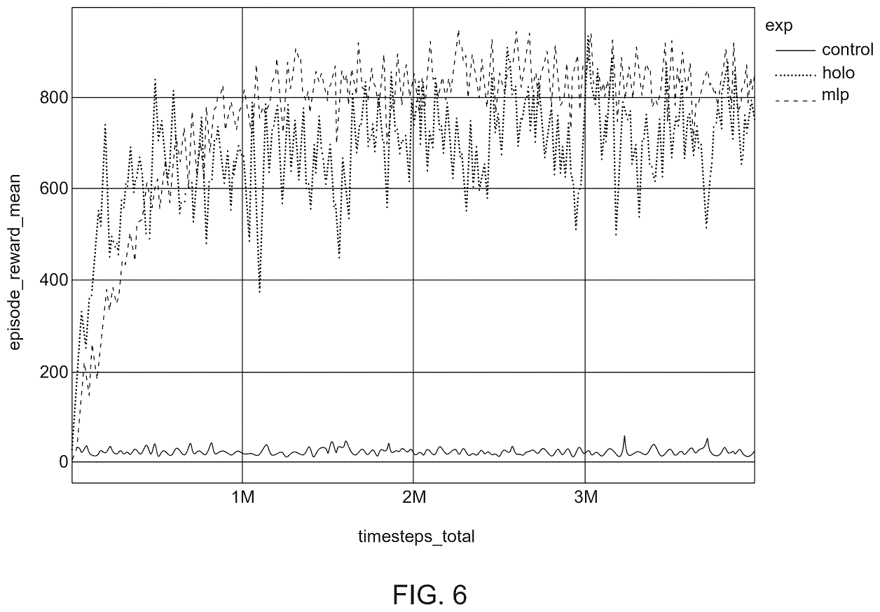

FIG. 6 shows performance of HTN compared to an MLP using holographic encodings. While less stable, the HTN trains more quickly than the MLP. While the HTN did not perform as well in the competition as previous rasterization methods with a convolutional neural network (CNN), after training a successful model, the HTN team subsequently corrected some issues that improved its performance.

In the Taxi and GymMaze environments, a policy choosing random actions, and a policy trained using Proximal Policy Optimization (PPO) as described in Schulman et al., Proximal Policy Optimization Algorithms, arXiv:1707.06347v2 [cs.LG]28 Aug. 2017, were tested. The policy parameters for PPO were generated by HTN and an MLP network, with both using the holographic encodings for the initial embedding.

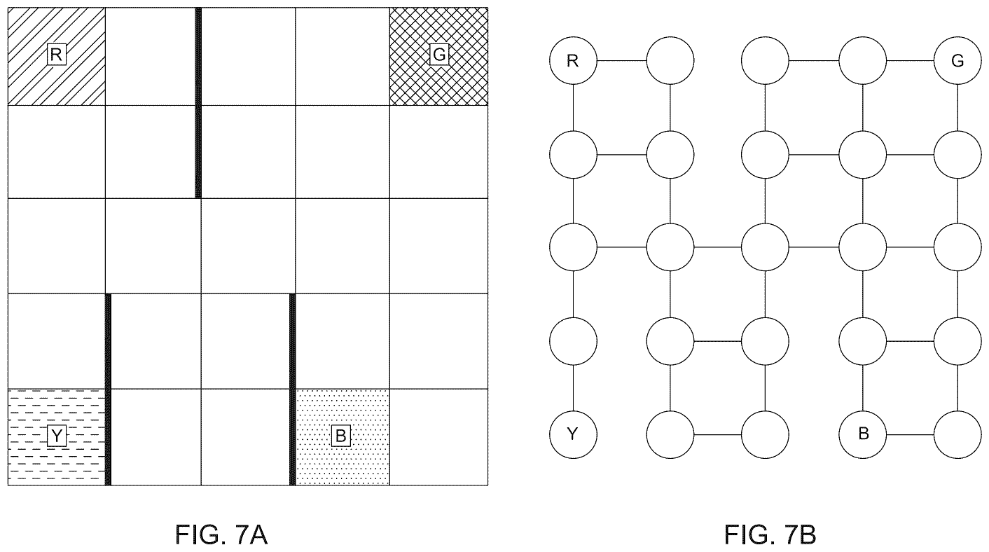

The Taxi environment by Gymnasium is structured on a bounded 5×5 grid. The object of the game is to have an agent pick up a passenger at one of the colored squares and drop them off at their destination at a different colored square (R=Red, G=Green, Y=Yellow, B=Blue). While the game naïvely takes place on the 5×5 grid, the grid is not Euclidean as far as gameplay due to barriers that prevent movement. Prior art FIG. 7A shows a simplified grid layout clearly depicting movement restrictions, and FIG. 7B depicts the non-Euclidean, graph nature of the environment.

The state space for Taxi is the Cartesian product of the taxi location, the passenger location, and the destination location. The taxi location is described by a tuple that indexes which node in the grid the taxi is on. The passenger and destination locations are described by an index in the range 0-4 and an index in the range 0-3, respectively. TABLE 2 provides descriptions for each index and the corresponding taxi location.

TABLE 2

| Index | Descriptor | Corresponding Taxi Location |
|---|---|---|
| 0 | Red (R) | (0, 0) |
| 1 | Green (G) | (4, 0) |
| 2 | Yellow (Y) | (0, 4) |
| 3 | Blue (B) | (3, 4) |
| 4* | Taxi | Dependent on taxi location |

*not applicable for destination

With the preceding description, the state space is the set of all 4-tuples (i, j, k, l) with the restrictions shown in TABLE 3:

TABLE 3

| | |
|---|---|
| 0 ≤ i, j < 5 | Taxi is in the grid |
| 0 ≤ k < 5 | Passenger is on one of the colored squares or |
| | is in the taxi |
| 0 ≤ l < 4 | The destination is on one of the colored squares |
| K ≠ l | The passenger location is not the same as the |
| | destination location* |

*Technically this condition is possible, but it is not reachable due to the starting configuration and win condition

Described in TABLE 2, the agent has six total actions, four of which are for movement and 2 of which are for interacting with the passenger.

TABLE 4

| Index | Description | Condition | Effect |
|---|---|---|---|
| 0 | Move South | Taxi can move south* | Taxi location += (1, 0) |
| 1 | Move North | Taxi can move north* | Taxi location += (−1, 0) |
| 2 | Move East | Taxi can move east* | Taxi location += (0, 1) |
| 3 | Move West | Taxi can move west* | Taxi location += (0, −1) |
| 4 | Pick up | Passenger location | Passenger location = 4 |
| | | index corresponds to | |
| | | taxi location tuple | |
| 5 | Drop off | Passenger location is 4, | Win |
| | | and destination location | |
| | | index corresponds to taxi | |
| | | location tuple | |

*whether the taxi can move in a particular direction if moving that direction would not cause the taxi to be outside of the grid and if doing so would not cross a barrier

The standard (built-in) reward function for this environment is described in TABLE 5. This reward function resulted in a saddle point where none of the agents would use the pickup or drop-off actions.

TABLE 5

| Condition | Reward |
|---|---|
| No other reward is triggered | −1 |
| Passenger delivered to destination | +20 |
| Pickup action executed, but resulted in noop | −10 |
| Drop-off action executed, but resulted in noop | −10 |

To resolve the saddle point issue of the standard reward we incentivize traveling toward the passenger and the destination with intermediate rewards. This reward function is shown in TABLE 6.

TABLE 6

| Condition | Reward |
|---|---|
| No other reward is triggered | −1 |
| Passenger delivered to destination | +20 |
| Passenger is not in taxi, and taxi is closer* to passenger | +1 |
| than it has been any all previous time steps | |
| Passenger is not in taxi, and taxi is not closer* to passenger | −1 |
| than it has been any all previous time steps | |
| Passenger is in taxi, and taxi is closer* to destination than it | +1 |
| has been in all prev. time steps where passenger is in the taxi | |
| Passenger is in taxi, and taxi is not closer* to destination | −1 |
| than it has been in all prev. time steps where passenger | |
| is in the taxi | |

*distance is calculated using the graph node distance and may not match up with the Euclidean distance.

The scenario ends if the passenger has been dropped off or the scenario lasts for more than 200 time steps.

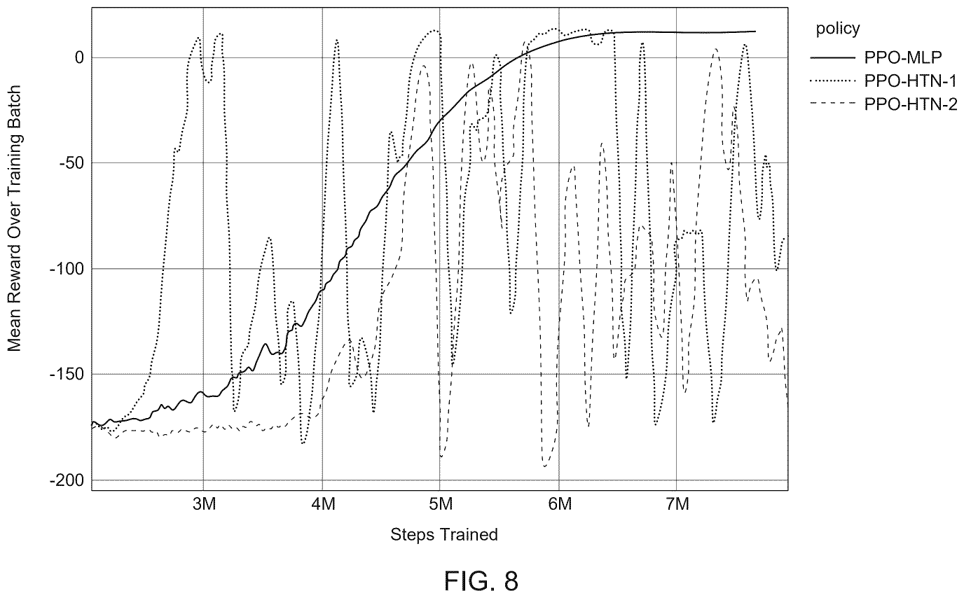

FIG. 8 shows the training curves for the policies tested. While HTN was less stable during training, it trained to a similar success rate as an MLP but in fewer epochs.

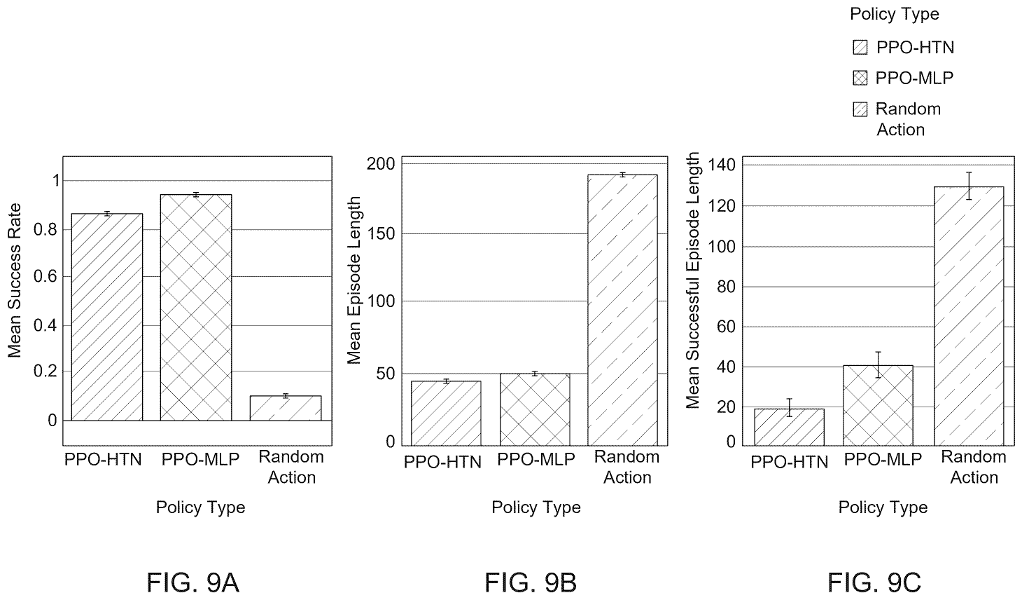

FIG. 9A shows the mean success rate for each policy type. While MLP is more successful overall, as FIG. 9B shows, HTN has a lower average episode length and for successful episodes, HTN completes the episode nearly twice as quickly as shown in FIG. 9C.

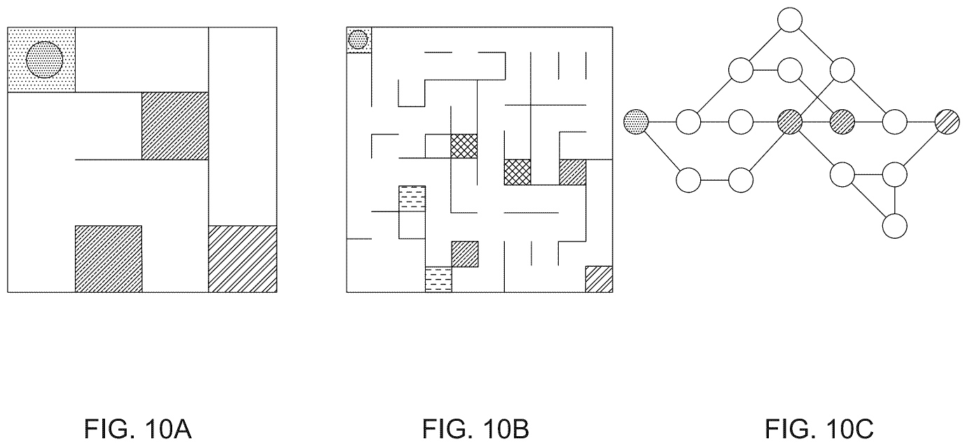

GymMaze is a 2D environment where the goal is for the agent (blue dot) to navigate from the top left corner of a grid to the bottom right corner of the grid. As in any maze, there are walls to block movement in particular directions. Additionally, there are also colored portal pairs, and, when the agent navigates to a portal tile, the agent is immediately teleported to the tile of the other portal in the pair. By way of example, prior art FIGS. 10A (3×3) and 10B (10×10) show different random mazes generated by the GymMaze environment, and FIG. 10C shows a graph representation of FIG. 10A.

For training, mazes of random sizes from 3×3 to 10×10 with random numbers of portals were generated. For testing, mazes of random sizes from 3×3 to 14×14 with random numbers of portals were generated.

For GymMaze, the state space consists of the maze map (including the position of the start square, goal square, and portal squares) and the position of the agent in the maze. There are 4 possible actions one to advance in each of the cardinal directions. A reward of 1 is given when the agent reaches the goal. For every step in the maze, the agent receives a reward of −0.1/(number of cells).

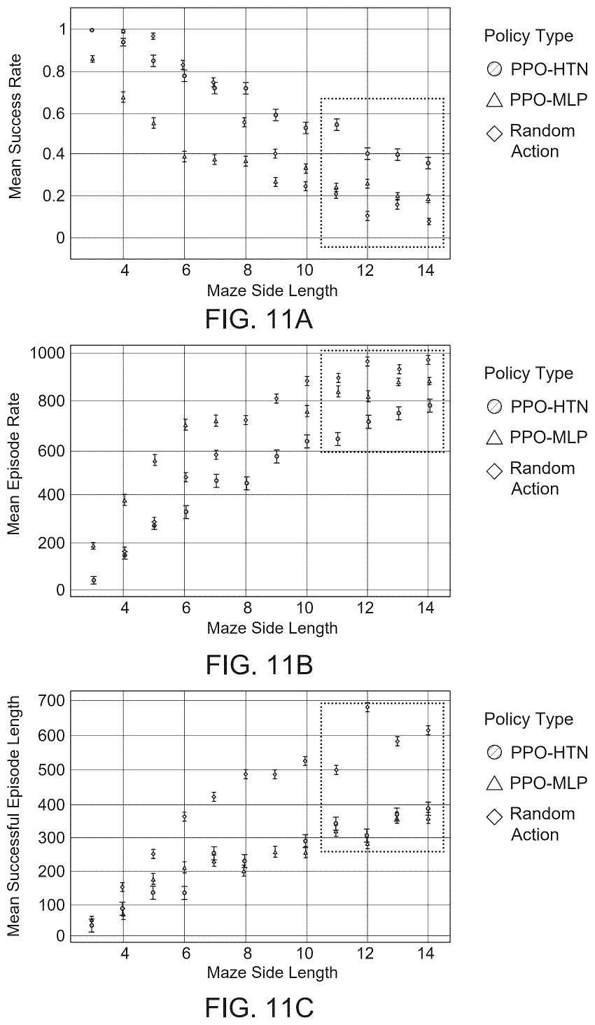

FIGS. 11A, 11B, 11C graph the results. Data points in boxed regions were generated from maze sizes the network had not previously been exposed to during training. FIG. 11A shows that HTN had similar success to a random walk for small maze sizes, and was more successful overall than the other models, especially in previously unseen maze sizes. FIG. 11B shows that HTN had lower episode lengths overall. FIG. 11C shows that compared to other policies, the lengths of HTN episodes were similar or shorter.

The embodiments described herein were performed on a gpu-g4dn-8xlarge EC2 instance. The specifications for that instance are as follows:
vCPUs: 32
Memory: 128.0 GiB
Physical Processor: Intel Xeon Family
Clock Speed: 2.5 GHz
CPU Architecture: x86_64
GPU: 1
GPU Architecture: NVIDIA T4 Tensor Core
Video Memory: 16.

One skilled in the art will appreciate the different hardware configurations which may be used to implement the embodiments described herein. Exemplary chip types include graphics processing units (GPUs), field programmable gate arrays (FPGAs), and application-specific integrated circuits (ASICs). FPGAs include logic blocks (i.e., modules that each contain a set of transistors) whose interconnections can be reconfigured by a programmer after fabrication to suit specific algorithms, while ASICs include hardwired circuitry customized to specific algorithms. The selection of particular hardware includes factors such as computational power, energy efficiency, cost, compatibility with existing hardware and software, scalability, and task (e.g., optimized for training or inference). For a detailed description of AI chip technology, see Khan et al., “AI Chips: What They Are and Why They Matter And AI Chips Reference,” CSET center for Security and Emerging Technology (April 2020) which is incorporated herein by reference in its entirety.

HTN has many features and capabilities that are useful for general learning, graph learning, and reinforcement learning. This method is more flexible than a Graph Neural Network (GNN) or Multi-Layer Perceptron (MLP), with comparable performance to both.

HTN does not require graph learning libraries such as PyTorch Geometric. This may be beneficial if certain libraries are not approved at certain customer sites.

HTN provides for improved data efficiency. The network trains faster and with fewer examples than a comparable MLP on many tasks. This is particularly helpful when it is difficult to obtain data for training or costly computationally, such as in Reinforcement Learning.

HTN provides for contextual integration. Embeddings generated from other embedding methods—such as those from Large Language Models (LLMs)—may be used in addition to the those the Holographic Encoder produces in natural language contexts.

HTN provides for forward self-compatibility. Unlike an MLP, adding a new feature only requires minor alterations to the architecture. The HTN architecture is inductive, meaning that pretrained weights can be used even when new features are added.

HTN provides for size independence. Unlike an MLP, and like an GNN, HTN does not require a change in architecture, and thus a loss of learned weights, when the context size changes. The HTN architecture is, by design, independent of the number of nodes, node features, edges, and edge features.

Unlike a GNN, HTN does not require that a graph structure be supplied to allow for message passing. The graph topology can be inferred from the node features. This is useful because the creation and experimentation with differing graph ontologies and topologies can be a time-consuming process for a machine learning engineer. An example of the inferred fuzzy graph is shown in FIG. 5C.

HTN provides for hierarchical structuring. When provided with a graph ontology, the HTN can be modified to allow for hierarchical structuring of the node embeddings based on that ontology. Therefore, when an ontology is known a priori, it can be provided to the network to aid in learning.

HTN provides for edge type prioritization. Unlike standard GNN architectures, which utilize the provided graph topology directly, for graphs with multiple edge types, the HTN can be tuned to simplify and reduce the network for targeted applications. By first including all edge types and using a linear layer with L2 normalization prior to the encoding step, one can force the network to choose the most important edge types. Once trained, observing the weights of that linear layer can determine which edge types are most important for the network, and then prune the input data appropriately.

The embodiments offer several distinct advantages over existing methods; particularly within the context of deep reinforcement learning (RL) with knowledge graphs. First, it allows for node-count mutability, meaning that the number of nodes in a knowledge graph can vary independently of the downstream processes, providing greater flexibility in handling dynamic and evolving knowledge graphs. Additionally, the graph structure can be directly utilized by the neural network rather than needing to be extracted from a flattened feature vector; this improves the integration and processing of relational information. Unlike stochastic node embedding methods such as FastRP, the embeddings produced by the present embodiments are not stochastic, ensuring consistency and reliability; moreover, unlike traditional trained embedding methods, such as node2vec, where the node embeddings themselves are learned, this invention enables a network to learn to create the embeddings explicitly; this simplifies and speeds up the learning process by removing an inner training loop at each step.

Our solution addresses the many limitations of using knowledge graph data for reinforcement learning by learning weights for a network that can provide explicit, non-stochastic, graph node embeddings in a manner that utilizes the knowledge graph structure natively in a node-count mutable way.

The following documents are part of the existing art and knowledge thereof by those skilled in the art is assumed for purposes of supporting enablement and written description of the present embodiments. The documents are incorporated herein by reference in their entireties: patent U.S. Ser. No. 11/836,577B2 for “Reinforcement learning model training through simulation” which focuses on the pipeline of a particular reinforcement learning service; patent U.S. Ser. No. 11/562,186B2 for “Capturing network dynamics using dynamic graph representation learning” which focuses on capturing temporal patterns of dynamic graph data; Patent Publication US20210326389A1 for “Dynamic graph representation learning via attention networks” which focuses on capturing temporal patterns in dynamic graph data to predict what a graph will look like after a small time step; patent U.S. Ser. No. 11/631,007B2 for “Method and device for text-enhanced knowledge graph joint representation learning” which focuses on applications to static lexical data and language translation; Patent Publication US20210027178A1 for “Recommendation method and recommendation apparatus based on deep reinforcement learning, and non-transitory computer-readable recording medium” which focuses on applications to recommendation systems; A. Vaswani et al. Attention Is All You Need. 31st Conference on Neural Information Processing Systems (NIPS 2017) which describes self-attention and transformers; R. Menegaux et al. Self-Attention in Colors: Another Take on Encoding Graph Structure in Transformers. TMLR. 2835-8856. 2017 which provides an example of graph classification that does not use a Graph Neural Network (GNN); K. Miyazaki et al. Conformer-Based Sound Event Detection With Semi-Supervised Learning and Data Augmentation. 2022 International Conference on Knowledge Engineering and Communication Systems (ICKES), Chickballapur, India (2022 IEEE) which is an example that uses a convolution transformer (conformer) architecture; and W. Ju et al. A Comprehensive Survey on Deep Graph Representation Learning. J. ACM, Vol. 1, No. 1, Article. Publication date: February 2024.

It is to be understood that the novel concepts described and illustrated herein may assume various alternative configurations which it is submitted fall within the scope of the embodiments. It is also to be understood that the specific systems, devices and processes illustrated in the attached drawings, and described herein, are simply exemplary embodiments of the embodied concepts defined in the appended claims.

We claim:

1. A system for producing graph encodings of a representative environment for use in a reinforcement learning (RL) process, the system comprising:
an ingestion component for ingesting knowledge graph (KG) data for the representative environment;
a pre-processing component for producing a true adjacency data representation of the ingested KG data, wherein the true adjacency data representation includes node and edge attributes of the KG data;
a holographic encoder for encoding the true adjacency data representation in accordance with selected encoding vectors; and
at least one holographic transformer for enriching the encoded true adjacency data representation to produce at least one enriched adjacency data representation including increased adjacency hops, wherein the at least one enriched adjacency data representation is used to produce a fuzzy adjacency data matrix for use in an RL process related to the representative environment.

2. The system of claim 1, wherein the selected encoding vectors are chosen for each node size to create an initial encoding of the true adjacency data representation.

3. The system of claim 1, wherein the at least one holographic transformer decodes the at least one enriched adjacency data representation into query and key vectors to produce the fuzzy adjacency data matrix.

4. The system of claim 1, wherein multiple holographic transformers are applied successively to enrich the encoded true adjacency data representation, producing multiple enriched adjacency data representations which are used to produce the fuzzy adjacency data matrix.

5. The system of claim 4, wherein the successive application of multiple holographic transformers adds increased adjacency orders.

6. The system of claim 1, wherein the knowledge graph (KG) data is of arbitrary-size with an arbitrary number of nodes or attributes and the encoded the true adjacency data representation is a single, fixed-size, set of vectors independent of the number of nodes or attributes in the KG graph.

7. A system for producing graph encodings of a representative environment for use in a reinforcement learning (RL) process, the system comprising:
an ingestion component for ingesting knowledge graph (KG) data for the representative environment;
a pre-processing component for producing a true adjacency data representation of the ingested KG data, wherein the true adjacency data representation includes node and edge attributes of the KG data;
a holographic encoder for encoding the true adjacency data representation in accordance with selected encoding vectors; and
multiple holographic transformers for successively enriching the encoded true adjacency data representation to produce multiple enriched adjacency data representations, wherein successive enriched adjacency data representations include increased adjacency orders, wherein the multiple enriched adjacency data representations are used to produce a fuzzy adjacency data matrix for use in an RL process related to the representative environment.

8. The system of claim 7, wherein the selected encoding vectors are chosen for each node size to create an initial encoding of the true adjacency data representation.

9. The system of claim 7, wherein the multiple holographic transformers decode the multiple enriched adjacency data representations into query and key vectors to produce the fuzzy adjacency data matrix.

10. The system of claim 7, wherein the knowledge graph (KG) data is of arbitrary-size with an arbitrary number of nodes or attributes and the encoded the true adjacency data representation is a single, fixed-size, set of vectors independent of the number of nodes or attributes in the KG graph.

11. A process for producing graph encodings of a representative environment for use in a reinforcement learning (RL) process, the process comprising:
ingesting, by an ingestion component, knowledge graph (KG) data for the representative environment;
producing, by a pre-processing component, a true adjacency data representation of the ingested KG data, wherein the true adjacency data representation includes node and edge attributes of the KG data;
selecting encoding vectors;
encoding, by a holographic encoder, the true adjacency data representation in accordance with selected encoding vectors;
enriching, by at least one holographic transformer, the encoded true adjacency data representation to produce at least one enriched adjacency data representation including increased adjacency hops; and
producing a fuzzy adjacency data matrix from the at least one enriched adjacency data representation for use in an RL process related to the representative environment.

12. The process of claim 11, wherein selecting encoding vectors includes choosing encoding vector for each node size to create an initial encoding of the true adjacency data representation.

13. The process of claim 11, further comprising:
decoding, by the at least one holographic transformer, the at least one enriched adjacency data representation into query and key vectors to produce the fuzzy adjacency data matrix.

14. The process of claim 11, further comprising:
successively applying multiple holographic transformers to enrich the encoded true adjacency data representation and producing multiple enriched adjacency data representations which are used to produce the fuzzy adjacency data matrix.

15. The process of claim 14, wherein the successive application of multiple holographic transformers adds increased adjacency orders.

16. The process of claim 11, wherein the knowledge graph (KG) data is of arbitrary-size with an arbitrary number of nodes or attributes and the encoding of the true adjacency data representation is to a single, fixed-size, set of vectors independent of the number of nodes or attributes in the KG graph.
